(19) United States
(12) Patent Application Publication
(10) Pub. No.: US 2013/0326104 A1
(43) Pub. Date: Dec. 5, 2013

(54) METHODOLOGY FOR USING SMARTPHONE AND MOBILE COMPUTER IN A MOBILE COMPUTE ENVIRONMENT

(71) Applicant: Timothy K. Strommen, Fremont, CA (US)

(72) Inventor: Timothy K. Strommen, Fremont, CA (US)

(73) Assignee: NVIDIA CORPORATION, Santa Clara, CA (US)

(21) Appl. No.: 13/487,020

(22) Filed: Jun. 1, 2012

(51) Int. Cl. G06F 13/00

(52) U.S. Cl. 710/304

(57) ABSTRACT

Embodiments of the present invention may be directed to an apparatus comprising a user interface docking device. The user interface docking device may include a first dock connector, a second dock connector, a battery, and a built-in keyboard. The first dock connector is operable to create a pairing between the user interface docking device and a wireless computing device. The second dock connector is operable to create a pairing between the user interface docking device and a mobile computer. The wireless computing device and mobile computer, when paired, are operable to combine resources for execution of tasks. The user interface docking device is operable to interact with content on the wireless computing device and the mobile computer. The apparatus may also include an inductive charging pad operable to facilitate a pairing between the number of peripheral units and user interface docking device via a near-field wireless connection.

### CROSS-REFERENCE TO RELATED APPLICATION

This application is related to patent application, “METHODOLOGY FOR USING SMARTPHONE IN DESKTOP OR MOBILE COMPUTE ENVIRONMENT,” concurrently filed with this application, with attorney docket number NVID-P-SC-11-0266-US1, which is herein incorporated by reference in its entirety.

### BACKGROUND OF THE INVENTION

Historical designs of desktop personal computers include a box or chassis containing the main computer components such as a power supply, central processing unit, memory, and data storage. Typically, attached to the box or chassis is a display device and one or more user interface devices for a user to interact with the personal computer.

With the advent of more powerful mobile central processing units, consumers now have mobile computing devices that include the major components of a traditional personal computer. However, the mobile form factor has some drawbacks such as limited screen-size, limited user interface area, and limited battery life preventing long-running applications typically used in a business environment from running.

Some specifications have attempted to address the limitations of mobile computing devices by mirroring the smaller mobile display to a larger external display. This type of mirroring currently requires a physical display connection, e.g. HDMI cable, to be connected from the mobile computing device to the larger external display. Some specifications have attempted to address the user interface limitation issue by using industry standard wired or wireless keyboards and mice to pair with the mobile computing device. However, these solutions require the user to manually set up the pairing with continued repeated effort for each device. Some specifications have attempted to address the limited battery life issue by requiring the user to plug in the mobile computing device to a physical power source. However, this solution also requires effort on the part of the user each time the user wishes use the mobile computing device in a mobile desktop environment.

These solutions have partly addressed the separate issues presented by a mobile computing environment ecosystem, however there is no integrated solution available allowing for a user to sit down with a mobile computing device and begin their workflow in a mobile computing environment with minimal user initial setup and effort.

### BRIEF SUMMARY OF THE INVENTION

Accordingly, a need exists for a methodology to integrate a smartphone and mobile computer into a desktop or mobile compute environment by combining multiple technologies into one harmonious solution.

Embodiments of the present invention are directed to an apparatus for a mobile compute environment. More specifically, the apparatus may include a user interface docking device having a first dock connector, a second dock connector, a battery, and a built-in keyboard. The first dock connector is operable to create a pairing between the user interface docking device and a wireless computing device. The second dock connector is operable to create a pairing between the user interface docking device and a mobile computer. The wireless computing device and mobile computer, when paired, are operable to combine resources for execution of tasks. The user interface docking device is operable to interact with content on the wireless computing device and the mobile computer.

Another embodiment of the present invention may be directed to an apparatus for a mobile compute environment where a first circuit is operable to create a wireless communication channel between a plurality of peripheral units and a user interface docking device. More specifically, the apparatus comprises an inductive charging pad operable to facilitate a pairing between the number of peripheral units and user interface docking device via a near-field wireless connection. The inductive charging pad is also operable to charge a battery of the user interface docking device.

Other embodiments of the present invention may be directed to a method of pairing a user interface docking device with a number of peripheral units. More specifically, the method may include detecting whether the user interface docking device is within proximity to an inductive charging pad. Upon detecting whether the user interface docking device is within proximity to the inductive charging pad, the method may also include creating a near-field wireless connection between the user interface docking device and the number of peripheral units. A configuration eligibility signal may be generated indicating eligibility of the user interface docking device to connect to the number of peripheral units. The method may also include connecting the user interface docking device to the number of peripheral units by creating a secure wireless session between the user interface docking and the number of peripheral units according to a wireless communication protocol.

### BRIEF DESCRIPTION OF THE DRAWINGS

The present invention is illustrated by way of example, and not by way of limitation, in the figures of the accompanying drawings and in which like reference numerals refer to similar elements.

FIG. 1 depicts a prior art personal computer system.

FIG. 2 depicts a prior art wireless computing device.

FIG. 3 depicts a prior art mobile computer.

FIG. 4A depicts an exemplary user interface docking device along with a wireless computing device and mobile computer, in accordance with one embodiment of the present invention.

FIG. 4B depicts an exemplary user interface docking device along with a wireless computing device and mobile computer attached to the user interface docking device, in accordance with one embodiment of the present invention.

FIG. 5 depicts an exemplary user interface docking device in proximity to an inductive charging pad, along with a wireless computing device, mobile computer, and peripheral devices, in accordance with one embodiment of the present invention.

FIG. 6 depicts a block diagram of a mobile compute environment in accordance with one embodiment of the present invention.

FIG. 7 depicts a wireless computing device operable as a user input device in accordance with one embodiment of the present invention.

FIG. 8 depicts a flowchart of an exemplary process of pairing a wireless computing device with a user interface device, according to some embodiments of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

For expository purposes, the term “horizontal” as used herein refers to a plane parallel to the plane or surface of an object, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

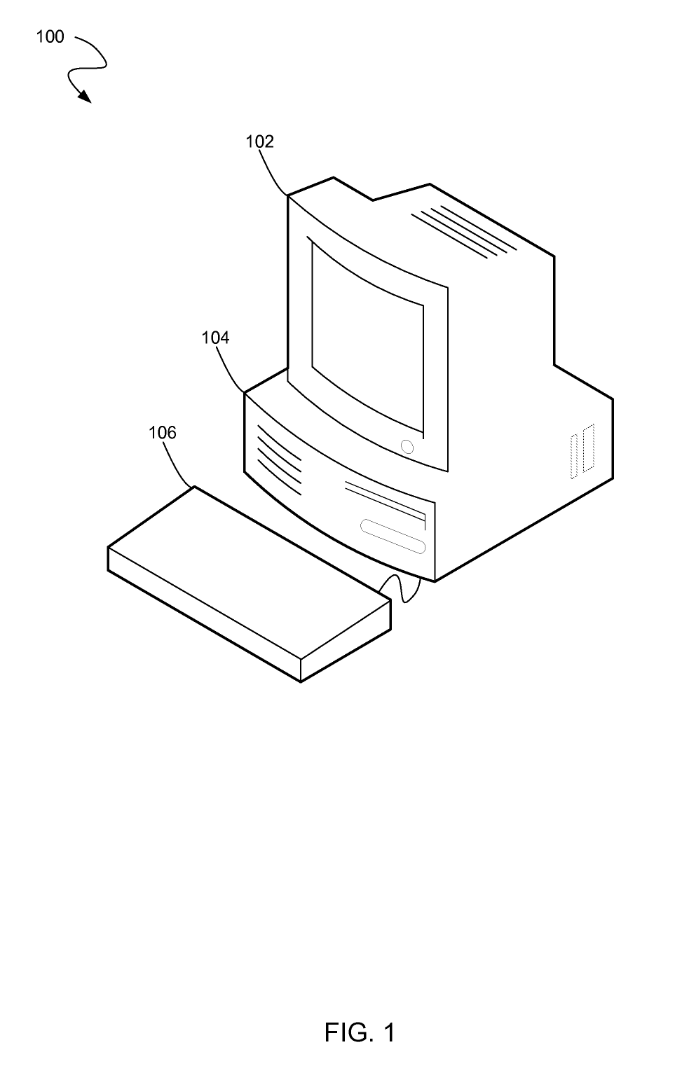

FIG. 1 depicts a prior art personal computer system 100. Personal computer system 100 is a general-purpose computer intended to be used by an end user. Personal computer system 100 or “desktop” system comprises display 102, tower 104, and user input device 106. Tower 104 includes the main hardware components of personal computer system 100. Tower 104 may include a power supply (not shown), a central processing unit (not shown), memory (not shown, and data storage drives (not shown). Display 102 is coupled to tower 104 and displays content of personal computer system 100. User input device 106 is coupled to tower 104 and is used to interact with personal computer system 100. User input device 106 may be coupled to tower 104 using wireless technology.

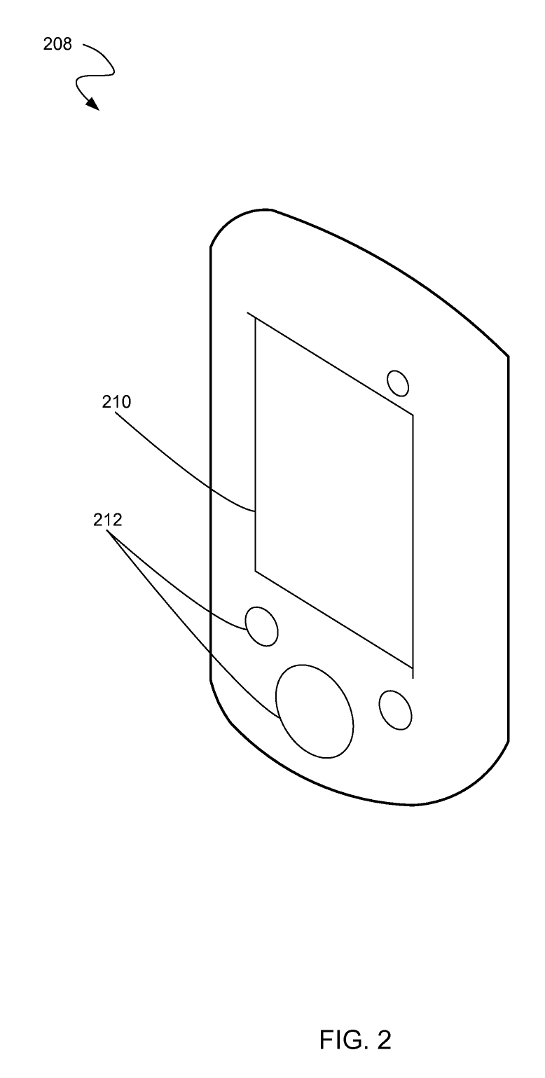

FIG. 2 depicts a prior art wireless computing device 208. Wireless computing device 208 may be a smartphone device, personal digital assistant device, or other mobile computing device. Typically, wireless computing device 208 has a powerful mobile CPU and includes all of the major components of a traditional personal computer system (FIG. 1) in a smaller handheld form factor. Wireless computing device 208 may include input/output connections (not shown) for interfacing with other devices. Additionally, wireless computing device 208 may include wireless connection capabilities such as, but not limited to, near-field communication (NFC), Bluetooth, and Wireless HDMI.

Wireless computing device 208 comprises a mobile display 210 and control buttons 212 for user interaction with the device. Typically, mobile display 210 has a limited viewing area due to screen size restrictions on wireless computing device 208. Wireless computing device 208 may be able to mirror content on mobile display 210 to a larger external display (not shown). However, such mirroring requires a physical display connection from wireless computing device 208 to the larger external display (not shown).

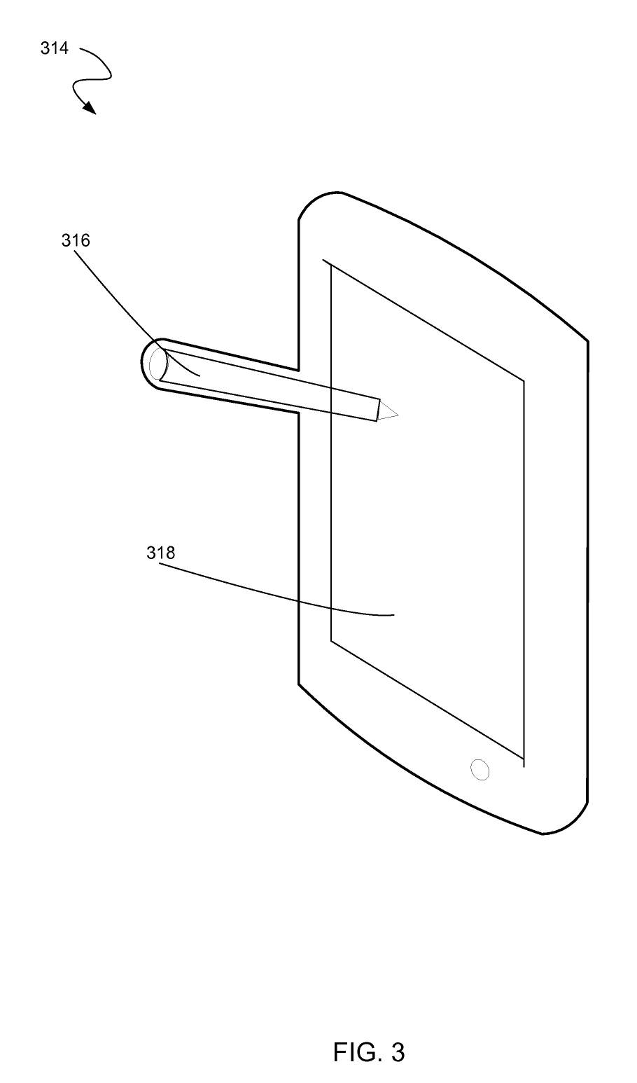

FIG. 3 depicts a prior art mobile computer 314. Typically, mobile computer 314 is a tablet computer having a touch screen display 318. Typically, mobile computer 314 has a powerful mobile CPU and includes all of the major components of a traditional personal computer system (FIG. 1) in a smaller form factor. Mobile computer 314 may include input/output connections (not shown) for interfacing with other devices. Additionally, mobile computer 314 may include wireless connection capabilities such as, but not limited to, near-field communication (NFC), Bluetooth, and Wireless HDMI. In general fashion, mobile computer 314 is longer in dimension compared to wireless computing device 208 (FIG. 2).

Content on mobile computer 314 of FIG. 3 may be navigated with gestures via a stylus 316 or with a user's finger or hand made on touch screen display 318. As stated above, mobile computer 314 typically has more processing power and a larger form factor than wireless computing device 208 (FIG. 2). Mobile computer 314 may be able to mirror content on touch screen display 316 to a larger external display (not shown). However, such mirroring requires a physical display connection from mobile computer 314 to the larger external display (not shown).

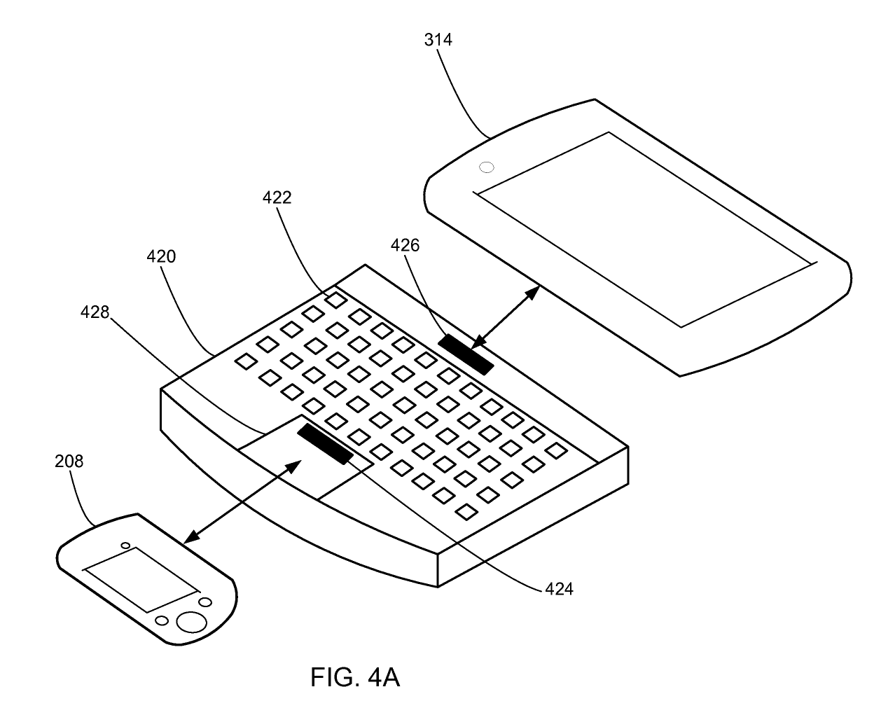

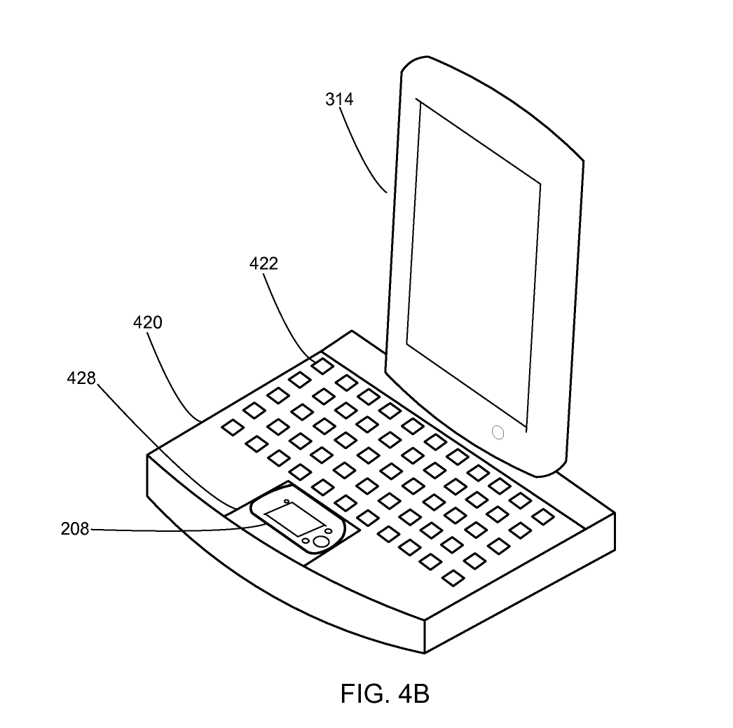

FIG. 4A depicts an exemplary user interface docking device along with a wireless computing device 208 and mobile computer 314, in accordance with one embodiment of the present invention. User interface docking device 420 includes a first dock connector 424 and a second dock connector 426. User interface docking device 420 also includes a built-in keyboard 422 and battery (not shown). User interface docking device 420 operates advantageously in conjunction with wireless computing device 428 and/or mobile computer 314.

The first dock connector 424 is operable to create a pairing between the user interface docking device 420 and the wireless computing device 208. Wireless computing device 208 includes a standardized connector (not shown) that can be coupled to the first dock connector 424. The first dock connector 424 is located within a slot 428 on user interface docking device 420. Slot 428 is operable to house wireless computing device 208. Upon placing wireless computing device 208 within slot 424 in the proper orientation, the standardized connector (not shown) on wireless computing device 208 is coupled to the first dock connector 424. Wireless computing device 208 may sit flush with a surface of user interface docking device 420 when wireless computing device 208 is inserted in the slot 428.

Upon wireless computing device 208 being inserted in slot 428 and the standardized connector (not shown) on wireless computing device 208 being coupled to the first dock connector 424, a pairing is initiated between wireless computing device 208 and user interface docking device 420. The pairing allows the use of built-in keyboard 422 to control content on wireless computing device 208 and for wireless computing device 208 to operate in conjunction with mobile computer 314, as described below.

In an embodiment, wireless computing device 208 may function as a user input device when housed in slot 428. For example, wireless computing device 208 may function as a touch pad when inserted in slot 428 allowing for navigation of content displayed on mobile computer 314 or on wireless computing device 208 itself. In an embodiment, wireless computing device 208 may automatically implement user input device functionality when inserted into slot 428.

The second dock connector 426 is operable to create a pairing between the user interface docking device 420 and the mobile computer 314. Mobile computer 314 includes a standardized connector (not shown) that can be coupled to the second dock connector 426. The second dock connector 426 is located at a base of user interface docking device 420 such that when mobile computer 314 is coupled to second dock connector 426, mobile computer 314 is positioned to serve as a display device for user interface docking device 420.

Upon the standardized connector (not shown) on mobile computer 314 being coupled to the second dock connector 426, a pairing is initiated between mobile computer 314 and user interface docking device 420. The pairing allows the use of built-in keyboard 422 to control content on mobile computer 314 and for wireless computing device 208 to operate in conjunction with mobile computer 314, as described below.

When wireless computing device 208 and mobile computer 314 are both paired with user interface docking device 420 via first dock connector 424 and second dock connector 426, wireless computing device 208 and mobile computer 314 may combine resources for execution of tasks. In an embodiment, wireless computing device 208 may serve as the primary processor while mobile computer 314 may serve as the secondary processor for the execution of tasks related to access of content on either wireless computing device 208 or mobile computer 314. In another embodiment, mobile computer 314 may serve as the primary processor while wireless computing device 208 may serve as the secondary processor for the execution of tasks related to access of content on either wireless computing device 208 or mobile computer 314.

In an embodiment, mobile computer 314 may piggy-back a data service connection available on wireless computing device 208, or vice versa. Typically, smartphone devices include wireless data service connections more often than tablet computer devices. When wireless computing device 208 and mobile computer 314 are both paired with user interface docking device 420 via first dock connector 424 and second dock connector 426, mobile computer 314 may make use of a wireless data service connection available on wireless computing device 208 to access a number of data services, e.g. Internet. The wireless data service connection available on wireless computing device 208 is shared to mobile computer 314 via user interface docking device 420.

User interface docking device 420 is operable to interact with content on wireless computing device 208 and/or mobile computer 314. When wireless computing device 208 and mobile computer 314 are both paired with user interface docking device 420, content on wireless computing device 208 and mobile computer 314 may be accessed via built-in keyboard 422 and wireless computing device 208 when functioning as a user input device (see above).

When wireless computing device 208 is removed from slot 428 and decoupled from first dock connector 424, the pairing between wireless computing device 208 and user interface docking device 420 is terminated. Additionally, when mobile computer 314 is decoupled from second dock connector 426, the pairing between mobile computer 314 and user interface docking device 420 is terminated.

FIG. 4B depicts an exemplary user interface docking device 420 along with a wireless computing device 208 and mobile computer 314 attached to the user interface docking device 420. Wireless computing device 208 is housed within slot 428 on user interface docking device 420 and coupled to first dock connector 424 (FIG. 4A). Additionally, mobile computer 314 is coupled to second dock connector 426 (FIG. 4B) and may function as a display device for wireless computing device 208 or as a stand-alone computing device. It can be appreciated that while mobile computer 314 is shown in a vertical orientation, mobile computer 314 may also interface with user interface docking device 420 while in a horizontal orientation.

As described above, when wireless computing device 208 is removed from slot 428 and decoupled from first dock connector 424 (FIG. 4A), the pairing between wireless computing device 208 and user interface docking device 420 is terminated. Additionally, when mobile computer 314 is decoupled from second dock connector 426 (FIG. 4A), the pairing between mobile computer 314 and user interface docking device 420 is terminated.

As described above, wireless computing device 208 may function as a user input device when housed in slot 428. For example, wireless computing device 208 may function as a touch pad when inserted in slot 428 allowing for navigation of content displayed on mobile computer 314 or on wireless computing device 208 itself. A user may drag their fingers across mobile display 210 (FIG. 2) on wireless computing device 208 to navigate content on mobile computer 314 or wireless computing device 208. In an embodiment, wireless display 210 may display widgets for navigation associated with shortcuts to commonly accessed content. In another embodiment, wireless computing device 208 may automatically implement user input device functionality when inserted into slot 428.

Second dock connector 426 (FIG. 4A) may have a rotatable base such that mobile computer 314 may be closed on top of user interface docking device 420. As described above, wireless computing device 208 sits flush to a surface of user interface docking device 420 such that wireless computing device 208 may remain in slot 428 when mobile computer 314 is closed on top. User interface docking device 420 may then be transported by a user to another location with wireless computing device 208 still housed in slot 428 and connected to first dock connector 424 (FIG. 4A), and mobile computer 314 still attached to second dock connector 426 (FIG. 4A).

In an embodiment, a simple LCD display (not shown) may replace mobile computer 314 and be used as a display with user interface docking device 420. The simple LCD display (not shown) can either mirror content from wireless computing device 208 or act as a secondary display increasing the total display real estate available on wireless computing device 208.

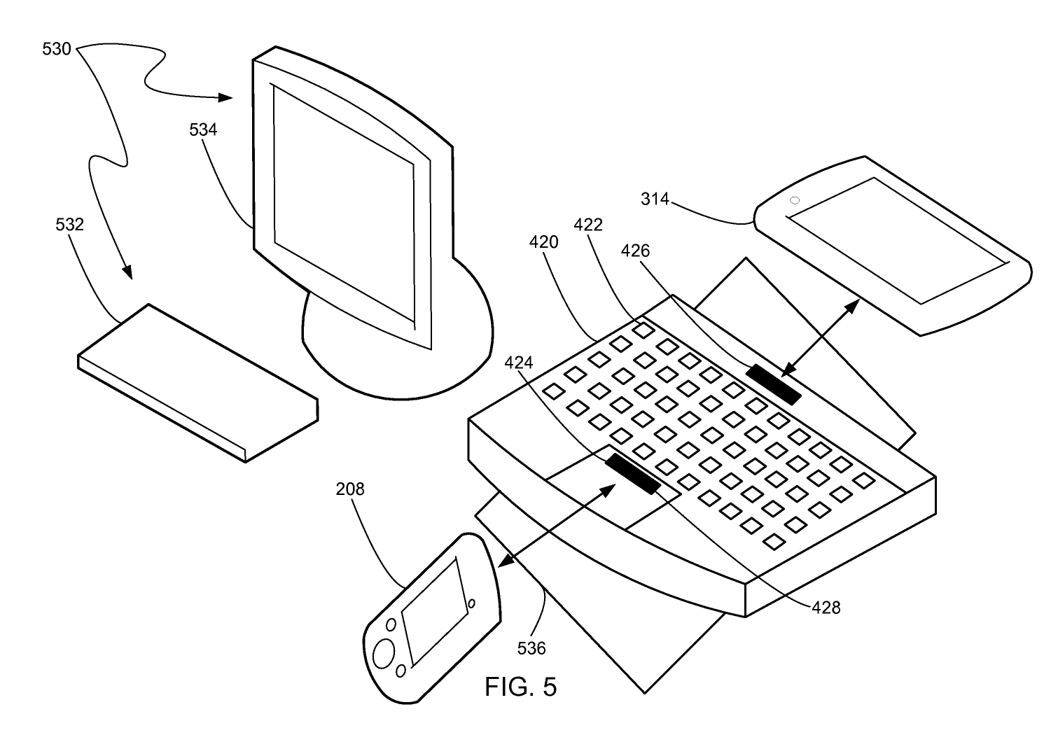

FIG. 5 depicts an exemplary user interface docking device 420 in proximity to an inductive charging pad 318, along with a wireless computing device 208, mobile computer 314, and peripheral units 530, in accordance with one embodiment of the present invention.

Peripheral units 530 may include a wireless keyboard 532 and a wireless display 534. Wireless keyboard 532 may incorporate a wireless communication protocol such as Bluetooth®. Wireless display 534 may incorporate a wireless communication protocol such as Wireless HDMI. The peripheral units include a circuit operable to create a wireless communication channel between the peripheral units and user interface docking device 420 using the above mentioned wireless communication protocols.

User interface docking device 420 may be coupled e.g., wired, with an inductive charging pad 536. Inductive charging pad 536 uses an electromagnetic field to transfer energy via inductive coupling to charge inductive charging pad 536 when in close proximity to the inductive charging pad 536. Additionally, inductive charging pad 536 includes a circuit operable to create a pairing between user interface docking device 420 and peripheral units 530 using Near Field Communication (NFC). NFC is a set of standards for wireless computing devices to establish radio communication with each other by bringing them into close proximity. In an embodiment, user interface docking device 420 charges wireless computing device 208 and mobile computer 314 when they are coupled to user interface docking device 420.

For instance, when user interface docking device 420 is brought into proximity of inductive charging pad 536 and is within an inductive power transfer field, inductive charging pad 536 will automatically associate with user interface docking device 420 via NFC and generate a configuration eligibility signal. The configuration eligibility signal indicates eligibility of user interface docking device 420 to connect to the peripheral units (wireless keyboard 532 and wireless display 534) via a wireless communication channel. If user interface docking device 420 is authorized to pair with wireless keyboard 532 and wireless display 534, the NFC connection will create a secure one-time session key for user interface docking device 420 to pair itself automatically with wireless keyboard 532 and wireless display 534 using the wireless communication protocols mentioned above. When wireless computing device 208 and mobile computer 314 are coupled to user interface docking device 420, peripheral units 530 may be used to interact with content on wireless computing device 208 and mobile computer 314.

A secure one-time session key is created for user interface docking device 420 to automatically pair with wireless keyboard 532 and wireless display 534. The NFC connection also includes information about the peripheral units necessary to create the wireless communication channel between the peripheral units and user interface docking device 420. For example, the NFC connection may include, but is not limited to, information about the manufacturer of the peripheral unit, battery life remaining for the peripheral unit, and the wireless communication protocol used by the peripheral unit, for instance.

Upon creation of the NFC connection between user interface docking device 420 and peripheral units 530, along with the wireless communication channel between user interface docking device 420 and peripheral units 530, the peripheral units (wireless keyboard 532 and wireless display 534) will be able to interact with content on the wireless computing device 208 and mobile computer 314. For example, wireless display 534 may either mirror content from wireless computing device 208 and mobile computer 314, or act as a secondary display increasing the total display real estate available on wireless computing device 208 and mobile computer 314. Additionally, wireless keyboard 532 may be used to input keystrokes and commands that control the content present on wireless computing device 208 and mobile computer 314.

When user interface docking device 420 is removed from proximity to inductive charging pad 536, the NFC connection between user interface docking device 420 and peripheral units 532 is terminated. Additionally, the wireless communication channel between the peripheral units 532 and user interface docking device 420 is terminated. By having the inductive charging pad 536 control the connectivity of the peripheral units and user interface docking device 420, more energy intensive interconnect technology may be used on wireless computing device 208 and mobile computer 314 without running their respective battery levels down.

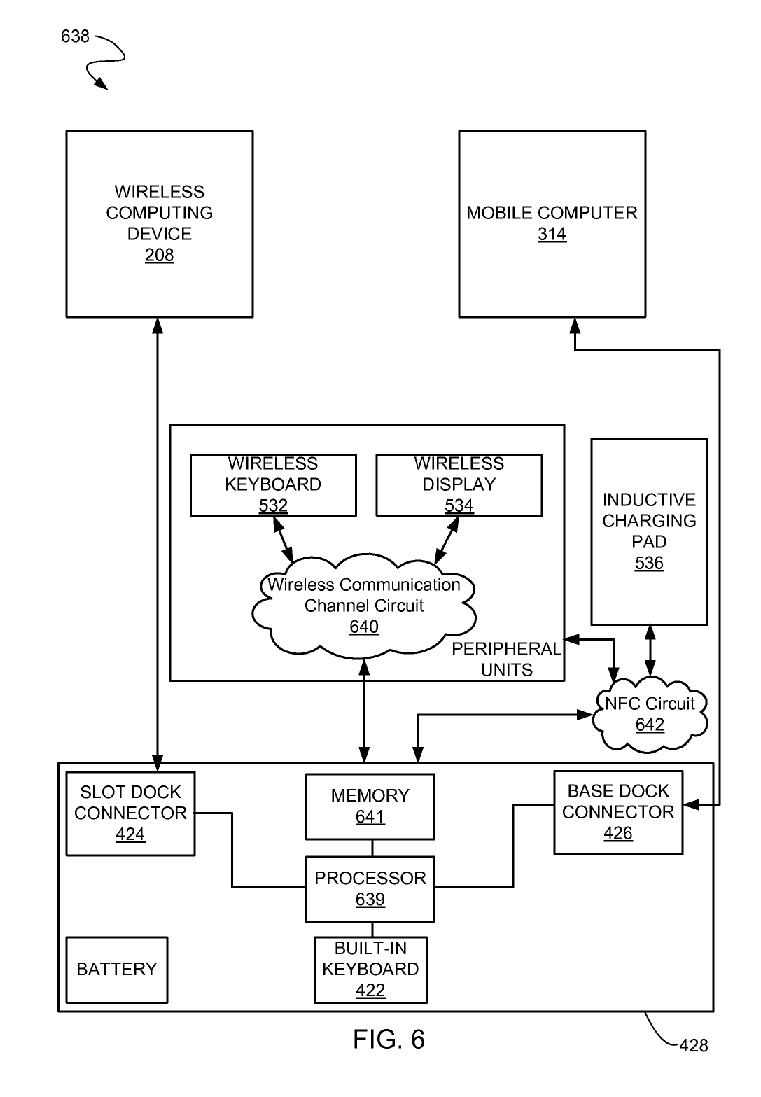

FIG. 6 depicts a block diagram of a mobile compute environment 638 in accordance with one embodiment of the present invention. Mobile compute environment 638 includes wireless computing device 208, mobile computer 314, inductive charging pad 536, user interface docking device 420, peripheral units, and NFC circuit 642. User interface docking device 420 includes a slot dock connector 424, base dock connector 426, built-in keyboard 422, processor 639, and onboard memory 641. Peripheral units include wireless keyboard 532, wireless display 534, and wireless communication channel circuit 640. As mentioned above, when user interface docking device 420 is brought into proximity of inductive charging pad 536 and is within an inductive power transfer field, inductive charging pad 536 will associate with user interface docking device 420 via NFC and facilitate a pairing between user interface docking device 420 and wireless keyboard 532 and wireless display 534.

A pairing between user interface docking device 420 and inductive charging pad 642 is created by a NFC connection via NFC circuit 642. Inductive charging pad 536 is responsible for handshaking and initialization of the NFC connection between user interface docking device 420 and the peripheral units when user interface docking device 420 is within proximity to inductive charging pad 536.

After initial pairing, a wireless communication channel is established between the peripheral units (wireless keyboard 532 and wireless display 534) and user interface docking device 420 via wireless communication channel circuit 640. Wireless communication channel 640 may use wireless protocols such as, but not limited to, Bluetooth® and Wireless HDMI. The pairing allows for interaction with content on wireless computing device 208 and mobile computer 314 via user interface docking device 420 by using peripheral units (wireless keyboard 532 and wireless display 534). In an embodiment, the NFC connection also includes information operable to create a secure session for user interface docking device 420 to pair with peripheral units.

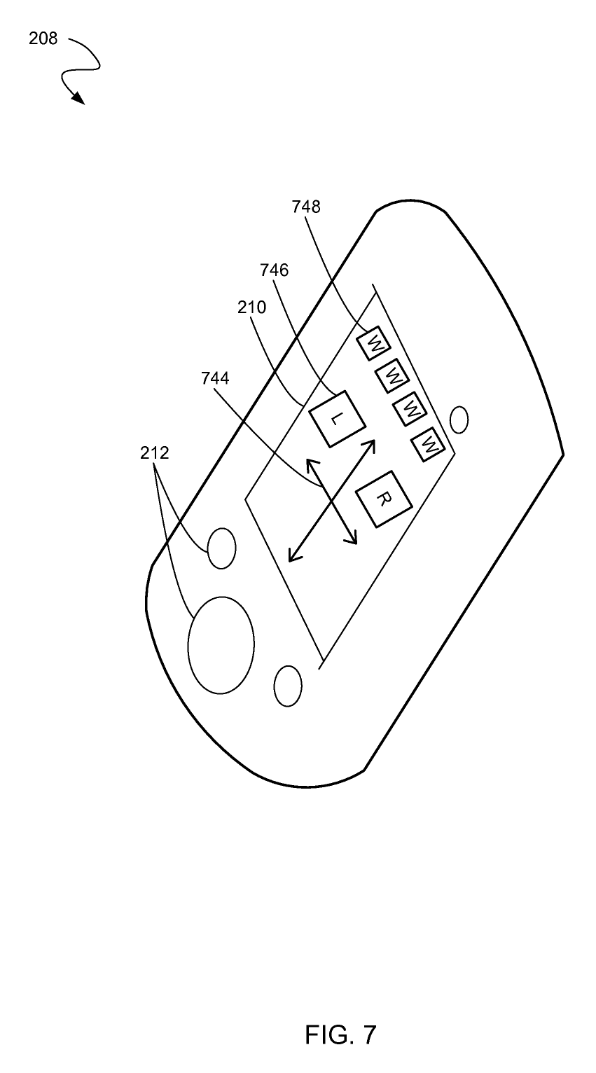

FIG. 7 depicts a wireless computing device 208 operable as a user input device in accordance with one embodiment of the present invention. Wireless computing device 208 comprises a mobile display 210 and control buttons 212 for user interaction with the device. In an embodiment, mobile display 210 may be a multi-touch display that recognizes gestures by a user. Additionally, wireless computing device may include graphical user interface (GUI) widgets 748, GUI arrows 744, and GUI buttons 746 within mobile display 210. GUI widgets 748 are user-definable shortcuts for accessing commonly used content on wireless computing device 208. GUI arrows 744 include up, down, left, and right arrows for navigation of content on wireless computing device 208. GUI buttons 746 include buttons corresponding to a left click and a right click for navigation of content on wireless computing device 208.

In an embodiment, wireless computing device 208 may automatically implement functionality as a user input device upon being placed in slot 428 on user interface docking device 420 (FIG. 4A). For example, upon placing wireless computing device 208 in slot 428, first dock connector 424 (FIG. 4A) will be coupled to wireless computing device 208 and pair wireless computing device 208 with user interface docking device 420, as described above. After the association and pairing, wireless computing device 208 may automatically implement user input device functionality so that the user may utilize GUI widgets 748, GUI arrows 744, and GUI buttons 746 for navigation of content on wireless computing device 208 and mobile computer 314 (FIG. 3).

In another embodiment, wireless computing device 208 is operable as a cursor-directing device. Wireless computing device 208 may automatically implement functionality as a user input device upon being placed in slot 428 on user interface docking device 420 (FIG. 4A). For example, upon placing wireless computing device 208 in slot 428, user interface docking device 420 (FIG. 4A) will associate with wireless computing device 208 via first dock connector 424 (FIG. 4A) and facilitate a pairing between wireless computing device 208 and user interface docking device 420 (FIG. 4A). Wireless computing device 208 may be used as a cursor-directing device, multi-touch input device, or as both simultaneously. A user may use their fingers to navigate content on wireless computing device 208.

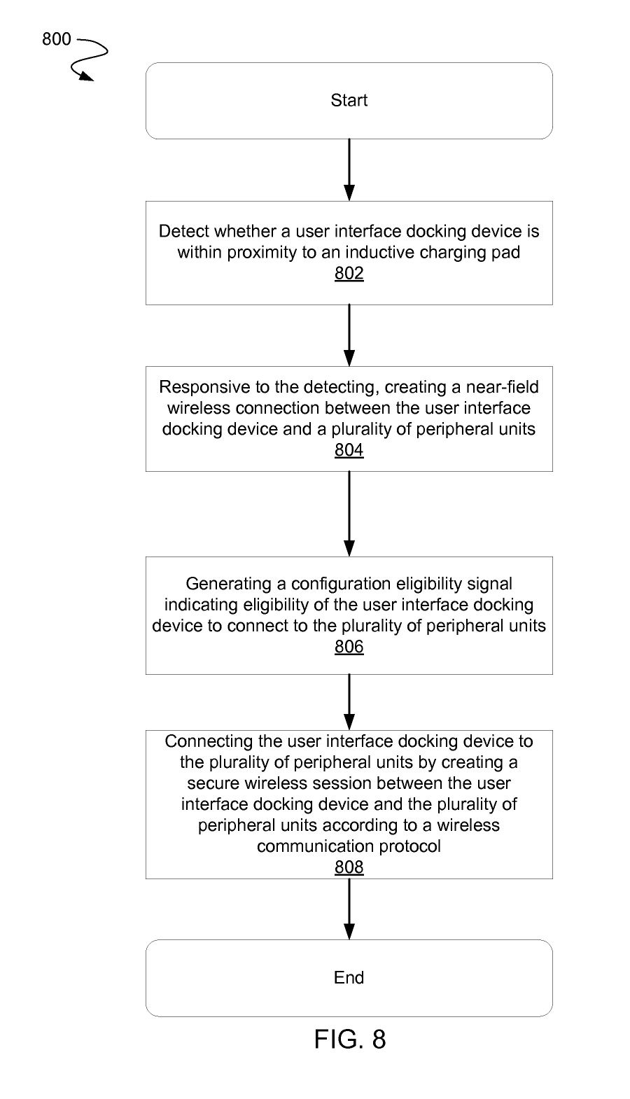

FIG. 8 depicts a flowchart 800 of an exemplary process of pairing a wireless computing device with a user interface device, according to some embodiments of the present invention. In a block 802, a determination is made whether a user interface docking device is detected within proximity to an inductive charging pad. The determination is made upon detection of a NFC communication between the user interface docking device and inductive charging pad. In an embodiment, the user interface docking device includes a first dock connector a second dock connector. The first dock connector is operable to create a pairing between the user interface docking device and a wireless computing device. The second dock connector is operable to create a pairing between the user interface docking device and a mobile computer. The wireless computing device and the mobile computer may combine resources for the execution of tasks.

For example, in FIG. 5, when user interface docking device is brought into proximity of inductive charging pad and is within an inductive power transfer field, inductive charging pad will determine that user interface docking device is within its proximity.

In a block 804, responsive to determining whether a user interface docking device is within proximity to the inductive charging pad in block 802, a NFC connection between the user interface docking device and a number of peripheral units is created. For example, in FIG. 5, when user interface docking device is brought into proximity of inductive charging pad and is within an inductive power transfer field, inductive charging pad will associate with the user interface docking device and initiate pairing between the user interface docking device and the number of peripheral units via a NFC connection. In an embodiment, the inductive charging pad may also charge the user interface docking device when the user interface docking device is in proximity to the inductive charging pad.

In a block 806, a configuration eligibility signal indicating eligibility of the user interface docking device to connect to the number of peripheral units is generated. For example, in FIG. 5, when user interface docking device is brought into proximity of inductive charging pad and is within an inductive power transfer field, inductive charging pad will associate with user interface docking device via a NFC connection and generate a configuration eligibility signal. The configuration eligibility signal indicates eligibility of user interface docking device to connect to the number of peripheral units of user interface docking device via a wireless communication channel.

In an embodiment, the number of peripheral units comprise a wireless keyboard and wireless display. In another embodiment, upon the inductive charging pad pairing the user interface docking device with the peripheral units, wireless computing device may automatically implement functionality as a user input device. For example, in FIG. 4, upon placing wireless computing device in a slot on the user interface docking device, wireless computing device may automatically implement user input device functionality so that the user may utilize GUI widgets, GUI arrows, and GUI buttons for navigation of content on wireless computing device that is being displayed on wireless display, as demonstrated in FIG. 7. In another embodiment, the wireless computing device may automatically implement functionality as a cursor-directing device.

In a block 808, upon successful pairing, a connection is created between the user interface docking device and the number of peripheral units by creating a secure wireless session between the user interface docking device and the number of peripheral units according to a wireless communication protocol. In an embodiment, the wireless communication protocols may be Bluetooth® and Wireless HDMI. For example, in FIG. 5, after generating the configuration eligibility signal in block 806, if user interface docking device is authorized to pair with wireless keyboard and wireless display, the NFC connection will create a secure one-time session key for user interface docking device to pair itself automatically with wireless keyboard and wireless display using the wireless communication protocols mentioned above.

When user interface docking device is removed from proximity to the inductive charging pad, the NFC connection between user interface docking device and the number of peripheral units and the wireless communication channel between the user interface docking device and the number of peripheral units are terminated. By having the inductive charging pad control the connectivity of the peripheral units and the user interface docking device, more energy intensive interconnect technology may be used on the wireless computing device without running its battery down.

In an embodiment, the wireless display mirrors content from the wireless computing device. In another embodiment, the wireless display acts as a secondary display for the wireless computing device. In yet another embodiment, user keyboard input from the wireless keyboard is received and communicated to the wireless computing device.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. An apparatus comprising:
a user interface docking device comprising:
a first dock connector and a second dock connector;
a battery; and
a built-in keyboard, wherein said first dock connector is operable to create a pairing between said user interface docking device and a wireless computing device, wherein further said second dock connector is operable to create a pairing between said user interface docking device and a mobile computer, wherein further said wireless computing device and said mobile computer when paired are operable to combine resources for execution of tasks, and wherein further said user interface docking device is operable to interact with content on said wireless computing device and said mobile computer.

2. The apparatus of claim 1 wherein said user interface docking device further comprises a slot for receiving and housing said wireless computing device, wherein further said first dock connector is disposed within said slot, wherein further said pairing between said user interface docking device and said wireless computing device is initiated upon said wireless computing device being inserted into said slot and coupled to said first dock connector, and wherein further said wireless computing device is operable as a user input device.

3. The apparatus of claim 2 wherein said pairing between said user interface docking device and said wireless computing device terminates upon removal of said wireless computing device from said slot and decoupling of said wireless computing device from said first dock connector.

4. The apparatus of claim 1 wherein said pairing between said user interface docking device and said mobile computer is initiated upon said mobile computer coupled to said second dock connector.

5. The apparatus of claim 4 wherein said pairing between said user interface docking device and said mobile computer terminates upon decoupling of said wireless computing device from said second dock connector.

6. The apparatus of claim 1 wherein said second dock connector is operable to create a pairing between said user interface docking device and a display device, wherein further said display device, when connected, is operable to mirror content on said wireless computing device or serve as a secondary display for said wireless computing device.

7. The apparatus of claim 1 wherein said wireless computing device is operable to share a wireless data service connection with said mobile computer via said user interface docking device.

8. The apparatus of claim 1 wherein said wireless computing device is a handheld mobile computing device comprising a display and input device, and wherein further said mobile computer is a tablet computer comprising a touchscreen display.

9. An apparatus comprising:
a user interface docking device comprising:
a first dock connector and a second dock connector;
a battery; and
a built-in keyboard, wherein said first dock connector is operable to create a pairing between said user interface docking device and a wireless computing device, and wherein further said second dock connector is operable to create a pairing between said user interface docking device and a mobile computer;
a plurality of peripheral units comprising a first circuit, wherein said first circuit is operable to create a wireless communication channel between said plurality of peripheral units and said user interface docking device via a wireless communication protocol.

10. The apparatus of claim 9 further comprising a second circuit and an inductive charging pad, wherein said inductive charging pad is operable for charging said battery, wherein further said inductive charging pad generates a configuration eligibility signal upon said user interface docking device placed in proximity to said inductive charging pad, wherein further said configuration eligibility signal indicates eligibility of said user interface docking device to connect to said plurality of plurality of peripheral units, and wherein further said second circuit is operable to create a pairing between said plurality of peripheral units and said user interface docking device and via a near-field wireless connection.

11. The apparatus of claim 10 wherein said first circuit is initiated to create said near-field wireless connection upon said user interface docking device placed in proximity to said inductive charging pad, and wherein further said near-field wireless connection comprises:
information about said plurality of peripheral units; and
information operable to create a secure session for said user interface docking device to pair with said plurality of peripheral units.

12. The apparatus of claim 10 wherein said near-field wireless connection and said wireless communication channels terminate upon removal of said user interface docking device from proximity to said inductive charging pad.

13. The apparatus of claim 9 wherein said wireless computing device is operable as a user input device and automatically implements functionality of said user input device upon coupling said wireless computing device to said first dock connector.

14. The apparatus of claim 11 wherein said user input device is a cursor directing device and wherein further said wireless computer comprises a multi-touch display operable to recognize navigation gestures when said wireless computer functions as a user input device.

15. The apparatus of claim 9 wherein said wireless computing device comprises a display operable to display:
graphical user interface widgets to access commonly used content on said wireless computing device or mobile computer;
graphical user interface arrows for navigation of content on said wireless computing device or mobile computer; and
graphical user interface buttons corresponding to a left click and right click for graphical user navigation of content on said wireless computing device or mobile computer.

16. The apparatus of claim 9 wherein said wireless communication protocol comprises Bluetooth or Wireless HDMI.

17. The apparatus of claim 9 wherein said plurality of user interface peripheral units comprise a wireless keyboard and a wireless display device, and wherein further said plurality of user interface peripheral units is used to interact with content on said wireless computing device or mobile computer.

18. The apparatus of claim 17 wherein said wireless display device is operable to mirror content on said wireless computing device or mobile computer, or serve as an additional display for said wireless computing device or mobile computer.

19. A method comprising:
detecting whether a user interface docking device is within proximity to an inductive charging pad;
responsive to said detecting, creating a near-field wireless connection between said user interface docking device and a plurality of peripheral units;
generating a configuration eligibility signal indicating eligibility of said user interface docking device to connect to said plurality of peripheral units; and
connecting said user interface docking device to said plurality of peripheral units by creating a secure wireless session between said user interface docking device and said plurality of peripheral units according to a wireless communication protocol.

20. The method of claim 19 wherein said user interface docking device comprises a first dock connector and a second dock connector, wherein further said first dock connector is operable to create a pairing between said user interface docking device and a wireless computing device, wherein further said second dock connector is operable to create a pairing between said user interface docking device and a mobile computer, and wherein further said wireless computing device and said mobile computer combine resources for execution of tasks.

21. The method of claim 20 wherein said plurality of peripheral units comprise a wireless display device and further comprising mirroring content from said wireless computing device or said mobile computer to said wireless display device.

22. The method of claim 20 further comprising initiating user interface functionality on said wireless computing device wherein said wireless computing device is operable as cursor directing device for said mobile computer.

23. The method of claim 20 wherein said plurality of peripheral units comprise a display and a keyboard and further comprising displaying information from said wireless computing device or mobile computer on said display and receiving user information from said keyboard and communicating said user information to said wireless computing device or mobile computer.

24. The method of claim 19 further comprising terminating said near-field wireless connection and said secure wireless session upon removal of said user interface docking device from proximity to said inductive charging pad.

25. The method of claim 19 further comprising charging said user interface docking device when said user interface docking device is within proximity to said inductive charging pad.
